(19) United States
(12) Patent Application Publication
(10) Pub. No.: US 2005/0113557 A1
(43) Pub. Date: May 26, 2005

(54) Process for the preparation of diamines and polyamines of the diphenylmethane series

(75) Inventor: Markus Dugal, Kempen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 10/960,322

(22) Filed: Oct. 7, 2004

(30) Foreign Application Priority Data
Oct. 13, 2003 (DE) 10347438.2

(51) Int. Cl. C08G 18/00

(52) U.S. Cl. 528/310

(57) ABSTRACT

Diamines and polyamines of the diphenylmethane series are produced by a) converting nitrobenzene and methanol simultaneously to aniline and formaldehyde in the presence of a catalyst, and b) converting the aniline and formaldehyde prepared in step a) to diamines and polyamines of the diphenylmethane series in the presence of an acidic catalyst. The diamines and polyamines produced by this process are particularly useful for the production of diisocyanates and polyisocyanates of the diphenylmethane series.

### BACKGROUND OF THE INVENTION

The present invention relates to a process for the preparation of diamines and polyamines of the diphenylmethane series (MDA) in which aniline and formaldehyde are simultaneously produced from nitrobenzene and methanol.

Aniline and formaldehyde are important intermediates inter alia for the polymer industry. For example, aniline and formaldehyde are used together as starting materials for the preparation of methylenediphenyldiamine and the corresponding polyamines (MDA) and methylenediphenyl diisocyanate and the corresponding polyisocyanates (MDI). Methylenediphenyl diisocyanate is an important monomer for the preparation of polyurethane. There are a number of processes for the preparation of aniline and formalin, some of which have been employed industrially. Aniline is currently prepared industrially by the catalytic gas phase hydrogenation of nitrobenzene with hydrogen in an adiabatic procedure (Hydrocarbon Process, 59 (November 1979) no. 11, 136; U.S. Pat. No. 3,636,152) or by an isothermal procedure (U.S. Pat. No. 4,265,834) using Cu or Pd catalysts. Processes of secondary importance are the reduction of nitrobenzene with iron (Bechamp process, Winnacker-Küchler Chemische Technologie, 3rd ed., vol. 4, pp 170-171) and the heterogeneously catalyzed gas phase ammonolysis of phenol (Halcon process, U.S. Pat. No. 3,272,865).

Formaldehyde is currently prepared on the industrial scale substantially by means of silver-catalyzed dehydrogenation processes (DE-A-2 322 757, U.S. Pat. No. 2,519,788) and the so-called formox process (GB-A-1 080 508).

In the silver-catalyzed processes, methanol is dehydrogenated with air at >600° C. on a silver catalyst to form formaldehyde and hydrogen. The hydrogen is converted to water with atmospheric oxygen in the subsequent course of the reaction or in downstream reaction stages in order to produce energy. The formox process comprises a two-stage oxidation of methanol to formaldehyde and water (oxidation-reduction cycle of the catalyst), which takes place at lower temperatures in the range 270-300° C., as a rule using molybdenum-iron catalysts.

An inevitable consequence of using these processes is that the products, aniline and formaldehyde, have to be prepared and worked up independently of one another in separate plants. The preparation of aniline, especially by the industrially significant hydrogenation processes, additionally requires the use of hydrogen as a cost-intensive reducing agent.

For the preparation of MDA by the acid-catalyzed conversion of aniline and formaldehyde, it would be advantageous to prepare the aniline and formaldehyde simultaneously in one process so that fewer plant sections are required and investment and operating costs can thereby be reduced. Furthermore, from the point of view of the material costs and the safety of the process, it would be advantageous in the reduction of nitrobenzene to aniline if the hydrogen used for hydrogenation were replaced by a more favorable and more easily manageable hydrogen source which releases hydrogen with the additional formation of a valuable product.

### SUMMARY OF THE INVENTION

The present invention provides a process for the preparation of diamines and polyamines of the diphenylmethane series in which aniline and formaldehyde that have been simultaneously produced are used as the starting materials and to a process for the production of isocyanates from these diamines and/or polyamines.

### DETAILED DESCRIPTION OF THE PRESENT INVENTION

The present invention relates to a process for the preparation of diamines and polyamines of the diphenylmethane series in which
a) nitrobenzene and methanol are converted to aniline and formaldehyde in the presence of a catalyst, and then
b) the aniline and formaldehyde prepared in step a) are converted to diamines and polyamines of the diphenylmethane series in the presence of an acidic catalyst.

In step a), nitrobenzene is reduced to aniline by a catalytic transfer reduction and methanol is simultaneously oxidized to formaldehyde. The preparation of aniline by the catalytic transfer reduction of nitrobenzene with methanol using a copper catalyst and a temperature of 180° is described by Rossi et al. (Gaz. Chim. It., 122, 1992, 221-223). Aniline is indicated as a reaction product with a 58% conversion. However, Rossi et al. discuss the theoretical possibility that formaldehyde, methyl formate, CO and CO₂ could be formed as reaction by-products, although no experimental proof of this is given. Rossi et al does not consider the possibility that the transfer reduction of nitrobenzene with methanol could yield a mixture of reaction products containing aniline and formaldehyde which could be used directly for the preparation of MDA.

Examples of suitable catalysts for the transfer reduction of nitrobenzene in step a) include inorganic catalysts that are insoluble in the reaction medium (heterogeneous catalysts) or soluble (homogeneous) metal complexes or salts, these catalysts containing one or more metals as catalytically active components in elemental or bound form. Examples of suitable metals are Pd, Pt, Rh, Ir, Ru, Fe, Co, Ni, Cu, Al, Mg, Zr, Zn, V, Cr, Mo, W, Pb and lanthanoids. It is preferable to use catalysts containing Pd, Pt, Ir, Ru, Cu or Fe.

The reaction of nitrobenzene with methanol in step a) is preferably carried out in the presence of auxiliary substances. Examples of suitable auxiliary substances are basic inorganic or organic compounds that are soluble or insoluble in the reaction medium, or solvents. Suitable bases are, e.g., hydroxides such as NaOH, KOH or NH₄OH; carbonates such as Na₂CO₃ or K₂CO₃; hydrogencarbonates such as NaHCO₃; amines such as triethylamine or aniline; or insoluble basic solids such as hydrotalcite, Al₂O₃ or MgO. Insoluble basic solids can optionally simultaneously serve as base and catalyst carrier. Preferred bases are NaOH, KOH, hydrotalcite or MgO.

Examples of suitable solvents are water, alcohols, organic amines and/or nitro compounds. Preferred solvents are the methanol, nitrobenzene, water and aniline participating in the reaction.

The aniline and formaldehyde-forming reaction can generally be carried out in the gas phase and/or in the liquid phase. Suitable reaction temperatures are conventionally in the range 20° C.-500° C., preferably in the range 50° C.-300° C. The absolute reaction pressure is conventionally in the range from 0.1 bar to 300 bar, preferably in the range from 1 bar to 100 bar. In principle, any concentrations and concentration ratios of the starting compounds and the auxiliary substances may be used. Depending on the choice of reaction conditions, partial or complete conversion, based on methanol or nitrobenzene, can be achieved in the reaction. As well as the target products, aniline and formaldehyde, possible reaction by-products are inter alia formic acid, CO, CO₂, carbonates, methyl formate, N-formylaniline, N-methylaniline and various aminals and half-aminals of aniline and formaldehyde. The type and concentration of the secondary components produced varies according to the catalyst used and the reaction conditions adopted.

The reaction products, aniline and formaldehyde, the secondary components which may be formed, unreacted nitrobenzene and methanol and the auxiliary substances used can be partially or completely separated from the reaction mixture and optionally worked up to the pure compounds before being used to produce the desired amine(s) or polyamine(s) of the diphenylmethane series. However, it is not necessary to separate them from the reaction mixture prior to production of the amine(s) or polyamine(s) of the diphenylmethane series. In principle, in addition to the preparation of MDA, aniline and/or formaldehyde obtained in step a) can also be put to other uses. Secondary compounds that may be isolated, e.g. CO or CO₂, are also available in principle for other uses. Unreacted nitrobenzene and/or methanol are preferably recycled into the step a) reaction.

Alternatively, it is possible for all or some of the reaction products, aniline and formaldehyde, together with the unreacted starting compounds, nitrobenzene and methanol, and optionally the auxiliary substances, to be left in the reaction mixture and converted directly to MDA in step b).

In step b) of the process of the present invention, the aniline and formaldehyde prepared in step a) are converted further to MDA, optionally after purification. For this purpose an acidic catalyst is added to the mixture containing aniline and formaldehyde.

Suitable acidic catalysts include strong organic or inorganic acids, for example hydrochloric acid, sulfuric acid, phosphoric acid, methanesulfonic acid or solid acids, e.g. zeolites. It is preferable to use hydrochloric acid.

As a rule, after a mixing phase and a preliminary reaction in the temperature range between 20° C. and 100° C., preferably in the temperature range from 30° C. to 80° C., the reaction mixture is brought in stages or continuously, and optionally under excess pressure, to a temperature of 100° C. to 250° C., preferably of 100° C. to 180° C. and particularly preferably of 100° C. to 160° C.

The reaction mixture subsequently obtained is then preferably neutralized with a base and the aqueous and organic phases are separated in a separating vessel. The MDA is present in the organic phase.

The invention further relates to a process for the preparation of diisocyanates and polyisocyanates of the diphenylmethane series, in which
a) nitrobenzene and methanol are simultaneously converted to aniline and formaldehyde in the presence of a catalyst,
b) the aniline and formaldehyde prepared in step a) are converted to diamines and polyamines of the diphenylmethane series in the presence of an acidic catalyst, and
c) the diamines and polyamines of the diphenylmethane series prepared in step b) are converted to diisocyanates and polyisocyanates of the diphenylmethane series by phosgenation.

For this purpose, the MDA prepared in step b) is reacted with phosgene by the known methods, in an inert organic solvent, to give the corresponding isocyanates. The molar ratio of crude MDA from step b) to phosgene is usefully proportioned so that the reaction mixture contains 1 to 10 mol, preferably 1.3 to 4 mol, of phosgene per mol of NH₂ groups. The following chlorinated aromatic hydrocarbons have proven to be suitable as inert solvents: monochlorobenzene, dichlorobenzenes, trichlorobenzenes, the corresponding toluenes and xylenes, and chloroethylbenzene. Monochlorobenzene, dichlorobenzene or mixtures of these chlorobenzenes are used in particular as inert organic solvents. The amount of solvent is generally proportioned so that the reaction mixture has an isocyanate content of 2 to 40 wt. %, preferably of between 5 and 20 wt. %, based on the total weight of the reaction mixture. When the phosgenation has ended, the excess phosgene, the inert organic solvent or mixtures thereof may be separated from the reaction mixture by distillation.

Having thus described the invention, the following examples are given as being illustrative thereof.

### EXAMPLES

### Examples of the Simultaneous Preparation of Aniline and Formaldehyde from Nitrobenzene and Methanol by Transfer Hydrogenation

### Examples 1-20

### Variation of the Catalyst Under Constant Reaction Conditions—Low Temperature

The experimental results and relevant batch data are collated in Table 1.

Procedure:

2.402 g (20 mmol) of nitrobenzene were placed in a round-bottom flask and 0.281 g (5 mmol) of KOH dissolved in 15.8 g of methanol and 0.6 g of naphthalene (internal standard) were added. A catalyst was added, with magnetic stirring, in an amount corresponding to 0.4 mmol of active metal in the particular catalyst used. The mixture was brought to reflux conditions in an oil bath (T=86° C.), with magnetic stirring, and a sample was taken after a certain reaction time and filtered. One part of the filtrate was analyzed for aniline and nitrobenzene content by gas chromatography (internal standard: naphthalene). Another part of the filtrate was reacted with so-called Nash reagent (T. Nash, Biochem. J., 55, 416, 1953). This enabled formaldehyde present to be analyzed photometrically (wavelength: 408 nm).

### Examples 21-28

### Variation of Insoluble MgO-Solid Base Catalyst Carrier—High Temperature

The experimental results and relevant batch data are collated in table 2

Procedure

1.201 g (10 mmol) nitrobenzene were placed in a stainless steel vessel with magnetic stir bar and 3.2 g of methanol were added. The catalyst was added in an amount corresponding to 0.2 mmol of Palladium supported on MgO as insoluble solid base (5 wt % Pd on MgO). The vessel was closed and heated to 180° C. in an oil bath for 3 h under magnetic stirring. After cooling, the catalyst was filtered off and one part of the filtrate was analysed by HPLC-chromatography. Another part of the filtrate was reacted with Nash reagent and analysed photometrically (see above).

TABLE 1*
Examples 1-20: Variation of the catalyst - low temperature

| | Catalyst (% = | | | | | | | |
|---|---|---|---|---|---|---|---|---|
| No. | percent by weight) | Metals | Support | t (h) | C [%] | S [%] | Y [%] | A/F |
| 1 | 10% Pd/C | Pd | Active charcoal (Aldrich) | 48 | 37.90 | 90.47 | 34.29 | 8.229460391 |
| 2 | 20 g/l of Cu on alumina | Cu | Alumina (Condea) | 48 | 17.71 | 1.75 | 0.31 | 2.833531701 |
| | (Al₂O₃) | | | | | | | |
| 3 | 20 g/l of Ni on alumina | Ni | Alumina (Condea) | 48 | 21.81 | 0.63 | 0.14 | 0.146611338 |
| | (Al₂O₃) | | | | | | | |
| 4 | 20 g/l of Ru on alumina | Ru | Alumina (Condea) | 48 | 18.43 | 21.04 | 3.88 | 0.901105975 |
| | (Al₂O₃) | | | | | | | |
| 5 | 2% of Pd on alumina | Pd | Alumina (Condea) | 48 | 18.03 | 15.28 | 2.76 | 0.843336715 |
| | (Al₂O₃) | | | | | | | |
| 6 | 0.588% of Cu | Cu, Fe, Cr, Mo, | Spheralite (=SPH) 501 | 48 | 11.27 | 1.40 | 0.16 | .092437402 |
| | 0.216% of Fe | Zn | (Al₂O₃, Rhodia) | | | | | |
| | 2.614% of Cr | | | | | | | |
| | 0.560% of Mo | | | | | | | |
| | 0.642% of Zn | | | | | | | |
| | 2% of NaOH on Spheralite | | | | | | | |
| | (=SPH) 501 (Al₂O₃) | | | | | | | |
| 7 | 1.5% of Zn + 1.5% of Cu | Cu, Zn | Cr oxide | 48 | 4.59 | 2.56 | 0.12 | 0.018546782 |
| | on Cr matrix | | | | | | | |
| 8 | 1.5% of Cu + 1.5% of Pd | Pd, Cu | Cr oxide | 48 | 11.03 | 55.81 | 6.16 | 0.822392298 |
| | on Cr matrix | | | | | | | |
| 9 | 1.5% of Cu, 1.5% of Zn + 1.5% | Pd, Cu, Zn | Cr oxide | 48 | 15.17 | 32.92 | 4.99 | 1.100314209 |
| | of Pd on Cr matrix | | | | | | | |
| 10 | 3% of Pd + 5% of NaOH on | Pd | SPH 501 (Rhodia) | 48 | 71.02 | 64.53 | 45.83 | 4.226413714 |
| | SPH 501 (Al₂O₃) | | | | | | | |
| 11 | 3% of Ru + 5% of NaOH on | Ru | SPH 501 (Rhodia) | 48 | 4.93 | 17.75 | 0.88 | 0.593633327 |
| | SPH 501 (Al₂O₃) | | | | | | | |
| 12 | 3% of Rh + 5% of NaOH on | Rh | SPH 501 (Rhodia) | 48 | 20.31 | 22.78 | 4.63 | 1.492302699 |
| | SPH 501 (Al₂O₃) | | | | | | | |
| 13 | 3% of Pt + 5% of NaOH on | Pt | SPH 501 (Rhodia) | 48 | 33.67 | 33.33 | 11.22 | 0.526037618 |
| | SPH 501 | | | | | | | |
| 14 | 4% of Ru (chloride) on MgO | Ru | MgO | 48 | 9.38 | 6.71 | 0.63 | 0.095063673 |
| | (30 mesh), washed Cl-free | | | | | | | |
| 15 | 4% of Co (chloride) on | Co | SPH 501 (Rhodia) | 48 | 5.91 | 1.39 | 0.08 | 0.074885373 |
| | Spheralite 501, 1.4-2.8 mm, Cl- | | | | | | | |
| | free | | | | | | | |
| 16 | 4% of Ni (chloride) on | Ni | SPH 501 (Rhodia) | 48 | 1.26 | 0.00 | 0.00 | 0 |
| | Spheralite 501 (Al₂O₃, Rhodia), | | | | | | | |
| | 1.4-2.8 mm, Cl-free | | | | | | | |
| 17 | 4% of Cu (chloride) on | Cu | SPH 501 (Rhodia) | 48 | 3.28 | 27.46 | 0.90 | 1.184254739 |
| | Spheralite 501 (Al₂O₃, Rhodia), | | | | | | | |
| | 1.4-2.8 mm, washed Cl-free | | | | | | | |
| 18 | Hydrotalcite | Fe, Mg, Al | Hydrotalcite | 48 | 10.06 | 22.06 | 2.22 | 0.407727292 |
| | Fe, Mg, Al (2.5% of Fe) | | | | | | | |
| 19 | Tris(triphenylphosphine)- | Ru | None | 48 | 14.41 | 22.03 | 3.17 | 2.06875702 |
| | ruthenium(II) chloride (10.5% | | | | | | | |
| | of Ru) | | | | | | | |
| 20 | 20 g/l of Ir on Condea alumina | Ir | Alumina (Condea) | 24 | 30.69 | 56.45 | 17.32 | 1.915449027 |
| | (Al₂O₃) | | | | | | | |

C = conversion of nitrobenzene,
S = selectivity in respect of aniline relative to nitrobenzene,
Y = yield of aniline,
A/F = molar ratio aniline/formaldehyde,
t = reaction time

TABLE 2
Examples 21-28. Variation of insoluble solid base catalyst carrier -
high Temperature

| | Support | | C | S | Y | |
|---|---|---|---|---|---|---|
| No | [MgO-Type] | Source | [%] | [%] | [%] | A/F |
| 21 | 325mesh/ | Aldrich | 26.90 | 88.76 | 23.88 | 7.24 |
| | 99.5% | | | | | |
| 22 | 30mesh/98% | Aldrich | 1.22 | 93.98 | 1.15 | 1.01 |
| 23 | p.A./>97% | Acros Organics | 15.12 | 92.39 | 13.97 | 3.09 |
| 24 | A.R.G. | Fisher Scientific | 39.959 | 94.177 | 37.633 | 6.75 |
| | >96% | | | | | |
| 25 | 100mesh/ | ABCR | 33.888 | 96.266 | 32.623 | 17.72 |
| | 99.5% | | | | | |
| 26 | light/ | Riedel de Haen | 18.329 | 90.342 | 16.558 | 4.17 |
| | 8-100.5% | | | | | |
| 27 | A.R.G./ | Fisher Scientific | 17.39 | 92.04 | 16.00 | 2.65 |
| | >96% | | | | | |
| 28 | A.R.G./ | Fisher Scientific | 13.00 | 90.26 | 11.74 | 3.67 |
| | >96% | | | | | |

2) Example of the Preparation of MDA

To prepare the aniline/formalin reaction mixture, 2.402 g (10 mmol) of nitrobenzene were placed in a screw-threaded V4A steel vessel and 0.14 g (0.25 mmol) of KOH dissolved in 8 g (250 mmol) of methanol was added. 0.2 g of a Pd/active charcoal catalyst (10 wt. % of Pd, Aldrich) was added, with magnetic stirring. The vessel was closed and placed in an oil bath at a temperature of 180° C.

The reaction was stopped after 3 h, the catalyst was filtered off and the mixture was analyzed by HPLC (Table 3) and Nash reaction/photometry (result: 0.15 wt. % of formaldehyde). One part (7 g) of the reaction mixture, containing 0.29 g (3.11 mmol) of aniline and 0.0106 g (0.35 mmol) of formaldehyde (molar ratio of aniline to formaldehyde: A/F=8.9), was then brought to a temperature of 45° C. in a round-bottom flask fitted with a magnetic stirrer, and HCl (aqueous solution) was added in the amount necessary for a degree of protonation of 18.5% (based on mol of aniline used). When the addition was ended, the mixture was stirred for 30 min at 45° C. and then heated slowly to the reflux temperature (approx. 105° C.) and stirred for 10 h at this temperature. When the reaction had ended, a sample was taken from the rearrangement mixture for HPLC analysis. The analytical results are shown in Table 4.

TABLE 3
Composition of the reaction mixture after reaction of nitrobenzene with
methanol, determined by HPLC (data in percent by weight, based on
total weight of reaction mixture)

| Aniline | Nitrobenzene | N-methylaniline |
|---|---|---|
| [wt. %] | [wt. %] | [wt. %] |
| 4.19 | 8.91 | 0.08 |

TABLE 4
HPLC analysis of the reaction mixture after MDA condensation (data in
percent by weight, nitrobenzene not evaluated)

| | | | | N-methyl- | 3-ring | | |
|---|---|---|---|---|---|---|---|
| Aniline | 4,4′-MDA | N-formyl- | 2,4′-MDA | aniline | species* | 4-ring | >4-ring |
| [wt. %] | [wt. %] | MDA [wt. %] | [wt. %] | [wt. %] | [wt. %] | species* | species* |
| 3.75 | 0.51 | 0.08 | 0.10 | 0.06 | 0.04 | 0.00 | 0.13 |

*more highly condensed MDA species (e.g. 3-ring species = reaction product of 3 aniline units + 2 formaldehyde units)

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of a diamine and/or polyamine of diphenylmethane comprising:
a) reacting nitrobenzene and methanol to form aniline and formaldehyde in the presence of a catalyst, and
b) converting the aniline and formaldehyde prepared in step a) to a diamine or polyamine of the diphenylmethane series in the presence of an acidic catalyst.

2. The process of claim 1 in which the catalyst used in step a) comprises one or more metals selected from Pd, Pt, Rh, Ir, Ru, Fe, Co, Ni, Cu, Al, Mg, Zr, Zn, V, Cr, Mo, W, Pb and lanthanoids, as a catalytically active component in elemental or bound form.

3. The process of claim 1 in which step a) is carried out in the presence of a base.

4. The process of claim 1 in which the aniline and/or formaldehyde is partially removed from the aniline and formaldehyde prepared in step a).

5. The process of claim 1 in which formic acid and/or CO and/or CO₂ and/or carbonates and/or methyl formate and/or N-formylaniline and/or N-methylaniline by-products are partially or completely separated from the aniline and formaldehyde prepared in step a) before carrying out step b).

6. The process of claim 1 in which hydrochloric acid is used as the acidic catalyst in step b).

7. A process for the production of a diisocyanate and/or polyisocyanate of diphenylmethane comprising:
a) reacting nitrobenzene and methanol to form aniline and formaldehyde in the presence of a catalyst,
b) converting the aniline and formaldehyde prepared in step a) to a diamine and/or polyamine of the diphenylmethane series in the presence of an acidic catalyst, and
c) phosgenating the diamine and/or polyamine of the diphenylmethane series prepared in step b) to produce a diisocyanate and/or polyisocyanate of the diphenylmethane series.

8. A process for the production of a diamine and/or polyamine of diphenylmethane consisting essentially of:
a) reacting nitrobenzene and methanol to form aniline and formaldehyde in the presence of a catalyst, and
b) converting the aniline and formaldehyde produced in step a) to a diamine and/or polyamine of diphenylmethane in the presence of an acidic catalyst.

9. The process of claim 8 in which the catalyst used in step a) is selected from the group consisting of Pd, Pt, Rh, Ir, Ru, Fe, Co, Ni, Cu, Al, Mg, Zr, Zn, V, Cr, Mo, W, Pb, lanthanoid metals in elemental or compound form.

10. The process of claim 8 in which step a) is carried out in the presence of a base.

11. The process of claim 8 in which step b) is carried out in the presence of a catalyst.

12. The process of claim 8 in which step b) is carried out in the presence of hydrochloric acid catalyst.

13. A process for the production of a diisocyanate and/or polyisocyanate of diphenylmethane comprising phosgenating the diamine or polyamine of diphenlymethane produced by the process of claim 8.

14. A process for the production of a diamine and/or polyamine of diphenylmethane consisting of:
a) reacting nitrobenzene and methanol to form aniline and formaldehyde in the presence of a catalyst and
b) converting the aniline and formaldehyde produced in step a) to a diamine and/or polyamine of diphenylmethane in the presence of an acidic catalyst.

15. The process of claim 14 in which the catalyst used in step a) is selected from the group consisting of Pd, Pt, Rh, Ir, Ru, Fe, Co, Ni, Cu, Al, Mg, Zr, Zn, V, Cr, Mo, W, Pb, and lathanoids in the form of metals or compounds.

16. The process of claim 14 in which step a) is carried out in the presence of a base.

17. The process of claim 14 in which hydrochloric acid is used as the acidic catalyst in step b).

18. A process for the production of a diisocyanate or polyisocyanate of diphenylmethane comprising phosgenating the diamine and/or polyamine of diphenylmethane produced in the process of claim 14.
